(19) United States
(12) Patent Application Publication
(10) Pub. No.: US 2016/0307121 A1
(43) Pub. Date: Oct. 20, 2016

(54) A METHOD OF PROCESSING A USER REQUEST WITHIN A SEARCH RESULT PAGE

(71) Applicant: YANDEX EUROPE AG, Luzern (CH)

(72) Inventors: Lev Arkadievich VOLOZH, Moscow (RU); Nikita Glebovich BLINOV, Moscow (RU)

(73) Assignee: YANDEX EUROPE AG, Luzren (CH)

(21) Appl. No.: 15/035,821

(22) PCT Filed: Nov. 15, 2013
(86) PCT No.: PCT/RU13/01026

§ 371 Date: May 11, 2016

(51) Int. Cl. G06Q 10/02; G06F 17/30

(52) U.S. Cl. CPC G06Q 10/02; G06F 17/30554; G06F 17/30864

(57) ABSTRACT

There is provided a method of displaying search results to a user in response to a search query. The method is executable at a server. The method comprises causing a display of a search result page (SERP) to the user, at least one line within the SERP having a booking interface associated with a resource, the booking interface enabling the user to execute a booking with the resource without leaving the SERP; the booking interface having a data component, the data component having been generated using one of: downloading a data component data from the resource as part generating the SERP: downloading the data component data from a memory as part of generating the SERP, the data component data having been stored in the memory at a point of time prior to the step of causing.

### CROSS-REFERENCE

None.

### FIELD

The present technology relates to search engines in general and specifically to a system and method for processing a user request within a search result page.

### BACKGROUND

Various global or local communications networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

Generally speaking, a given user can access a resource on the communications network by two principle means. The given user can access a particular resource directly, either by typing an address of the resource (typically an URL or Universal Resource Locator, such as www.webpage.com) or by clicking a link in an e-mail or in another web resource. Alternatively, the given user may conduct a search using a search engine to locate a resource of interest. The latter is particularly suitable in those circumstances, where the given user knows a topic of interest, but does not know the exact address of the resource she is interested in.

There, are numerous search engines available to the user. Some of them are considered to be general purpose search engines (such as Yandex™, Google™, Yahoo™ and the like). Others are considered to be vertical search engines—i.e. search engines dedicated to a particular topic of search—such as Momondo™ search engine dedicated to searching flights.

Irrespective of which search engine is used, the search engine is generally configured to receive a search query from a user, to perform a search and to return a ranked search result page (SERP) to the user. Several attempts have been made to improve the design of the SERP in the strive to enable the user to more easily and faster appreciate search results. Generally speaking, the SERP provides a list of ranked search results to the user. The ranked search results list is meant to enable the user to quickly locate the resource she is interested in and to enable her to select the resource that is most responsive to her query (by selecting, the user would typically be redirected onto a webpage associated with the resource).

In some circumstances, the user is not looking for an answer to her question per se, but is rather looking to perform a transaction with a particular resource (for example, book an appointment with a hairdresser, purchase movie tickets and the like). When the user does not know the exact web address (i.e. the URL) associated with the web site of a particular resource, the user will typically access a search engine and search for the resource. The user then needs to select the resource and to navigate to the required page associated with a booking functionality. Some search engine, as part of the resource information snippet outputted within the SERP provide sub-links to sub-resources of the web site associated with the resource. However, it does not always happen that the requisite links is presented within the SERP and the user may still “waste” clicks to navigate to the correct page within the resource.

PCT patent application 2012/160567 discloses a system and method for dynamic and active search engine. A method includes displaying active resources and active search results based on monitoring, tracking, crawling, registering, subscribing, identifying active resources from one or more sources, receiving, updating, recording, logging, storing, indexing and processing said active resources and active searchable resources from one or more sources and generating, updating, sending, publishing, presenting & providing request and/or search query specific active resources or active search results to active searching user or requestor. A method enables dynamic, customize, unified active search engine, active search results, active ranking, and active advertisements based on identified, dynamic, contextual & accessible active link(s).

### SUMMARY

It is an object of the present technology to ameliorate at least some of the inconveniences present in the prior art.

According to a first broad aspect of the present technology, there s provided a method of displaying search results to a user in response to a search query. The method is executable at a server. The method comprises causing a display of a search result page (SERP) to the user, at least one line within the SERP having a booking interface associated with a resource, the booking interface enabling the user to execute a booking with the resource without leaving the SERP; the booking interface having a data component, the data component having been generated using one of: downloading a data component data from the resource as part generating the SERP; downloading the data component data from a memory as part of generating the SERP, the data component data having been stored in the memory at a point of time prior to said causing.

In some implementations of the present technology, the display of the search result page (SERP) to the user includes displaying at least one line within the SERP having a first booking interface associated with a first resource and a second search line having a second booking interface associated with a second resource. The first resource may be different from the second resource. In some implementations, the first booking interface and the second booking interface allow the user to interact with them independently from each other. In some implementations, the first booking interface and the second booking interface allow the user to make a booking substantially at the same time.

In some implementations where the data component data has been generated by means of downloading the data component data from the resource as part generating the SERP, the method further comprises downloading the data component data.

In some implementations, downloading the data component data comprises downloading the data component data from the resource. The downloading can be executed by means of an application program interface (API).

In some implementations where the data component data has been generated by means of downloading the data component data from a memory as part of generating the SERP, the method further comprises downloading the data component data from the memory. In these implementations, the method further comprises receiving the data component data and storing it in the memory, both receiving and storing being executed prior to the step of causing. The receiving can be executed by means of an application program interface (API).

In some implementations, the booking interface allows the user to input booking data. The method may further comprise causing transmission of the booking data to the resource. The transmission can be executed via an application program interface (API).

In some implementations, the data component is a first data component and the booking interface comprises a second data component, wherein the first data component is generated by downloading the first data component data from the resource as part generating the SERP; the second data component is generated by downloading a second data component data component data from a memory as part of generating the SERP, the second data component data having been stored in the memory at a point of time prior to the step of causing.

According to another broad aspect of the present technology, there is provided a server having a non-transient computer usable information storage medium that stores computer executable instructions, which instructions when executed are configured to render the server operable to execute: causing a display of a search result page (SERP) to the user, at least one line within the SERP having a booking interface associated with a resource, the booking interface enabling the user to execute a booking with the resource without leaving the SERP; the booking interface having a data component, the data component having been generated using one of: downloading a data component data from the resource as part generating the SERP; downloading the data component data from a memory as part of generating the SERP, the data component data having been stored in the memory at a point of time prior to the step of causing.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram depicting a system 100, the system 100 being implemented in accordance with non-limiting embodiments of the present technology.

FIG. 2 depicts a screen shot 200, the screen shot 200 depicting the search application 104 implemented in accordance with embodiments of the present technology.

FIG. 3 depicts a block diagram of a method of displaying search results to a user in response to a search query, the method executable at the server 100 of Figure land being implemented in accordance with embodiments of the present technology.

### DETAILED DESCRIPTION

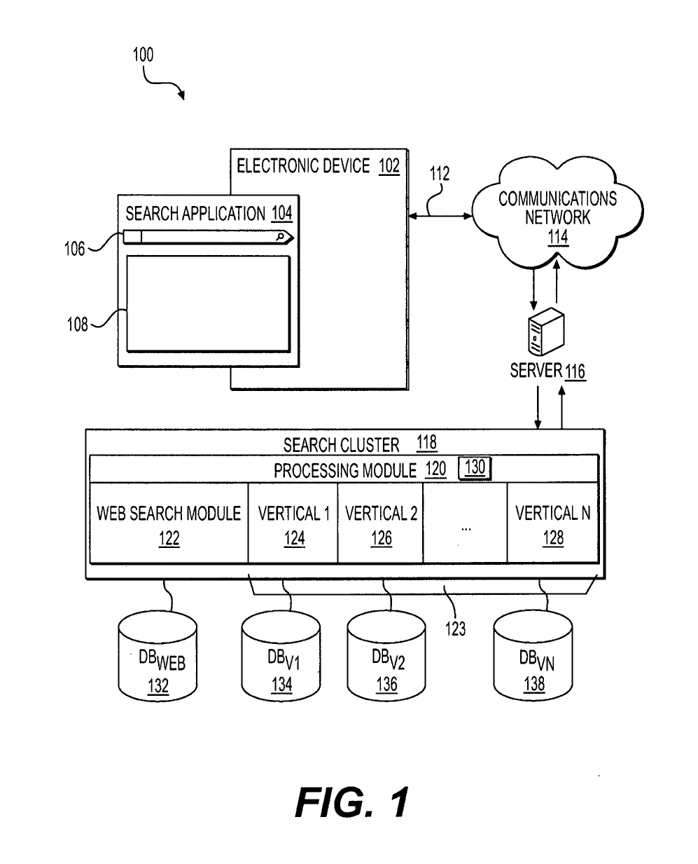

Referring to FIG. 1, there is shown a schematic diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises an electronic device 102. The electronic device 102 is typically associated with a user (not depicted) and, as such, can sometimes be referred to as a “client device”. It should be noted that the fact that the electronic device 102 is associated with the user does not need to suggest or imply any mode of operation—such as a need to log in, a need to be registered or the like.

The implementation of the electronic device 102 is not particularly limited, but as an example, the electronic device 102 may be implemented as a personal computer (desktops, laptops, netbooks, etc.), a wireless communication device (a cell phone, a smartphone, a tablet and the like), as well as network equipment (a router, a switch, or a gateway). The electronic device 102 comprises hardware and/or software and/or firmware (or a combination thereof), as is known in the art, to execute a search application 104. Generally speaking, the purpose of the search application 104 is to enable the user (not depicted) to execute a search, such as the above mentioned web search using the above-mentioned search engine.

How the search application 104 is implemented is not particularly limited. One example of the search application 104 may be embodied in a user accessing a web site associated with a search engine to access the search application 104. For example, the search application can be accessed by typing in an URL associated with Yandex search engine at www.yandex.ru. It should be expressly understood that the search application 104 can be accessed using any other commercially available or proprietary search engine.

In alternative non-limiting embodiments of the present technology, the search application 104 may be implemented as a browser application on a portable device (such as a wireless communication device). For example (but not limited) to those implementations, where the electronic device 102 is implemented as a portable device, such as for example, Samsung™ Galaxy™ SIII, the electronic device may be executing a Yandex browser application. It should be expressly understood that any other commercially available or proprietary browser application can be used for implementing non-limiting embodiments of the present technology.

Generally, speaking, the search application 104 comprises a query interface 106 and a search result interface 108. The general purpose of the query interface 106 is to enable the user (not depicted) to enter her query or a “search string”. The general purpose of the search result interface 108 is to provide search results that are responsive to the user query entered into the query interface 106. How the user query is processed and how the search results are presented will be described in detail herein below.

The electronic device 102 is coupled to a communications network 114 via a communication link 112. In some non-limiting embodiments of the present technology, the communications network 114 can be implemented as the Internet. In other embodiments of the present technology, the communications network 114 can be implemented differently, such as any wide-area communications network, local-area communications network, a private communications network and the like.

How the communication link 112 is implemented is not particularly limited and will depend on how the communication device 102 is implemented. Merely as an example and not as a limitation, in those embodiments of the present technology where the electronic device 102 is implemented as a wireless communication device (such as a smart-phone), the communicated link 102 can be implemented as a wireless communication link (such as but not limited to, a 3G communications network link, a 4G communications network link, a Wireless Fidelity, or WiFi® for short, Bluetooth® and the like). In those examples, where the communication device 102 is implemented as a notebook computer, the communication link can be either wireless (such as the Wireless Fidelity, or WiFi® for short, Bluetooth® or the like) or wired (such as an Ethernet based connection).

It should be expressly understood that implementations for the electronic device 102, the communication link 112 and the communications network 114 are provided for illustration purposes only. As such, those skilled in the art will easily appreciate other specific implementational details for the electronic device 102, the communication link 112 and the communications network 114. As such, by no means, examples provided herein above are meant to limit the scope of the present technology.

Also coupled to the communications network is a server 116. The server 116 can be implemented as a conventional computer server. In an example of an embodiment of the present technology, the server 116 can be implemented as a Dell™ PowerEdge™ Server running the Microsoft™ Windows Server™ operating system. Needless to say, the server 116 can be implemented in any other suitable hardware and/or software and/or firmware or a combination thereof. In the depicted non-limiting embodiment of present technology, the server 116 is a single server. In alternative non-limiting embodiments of the present technology, the functionality of the server 116 may be distributed and may be implemented via multiple servers.

The server 116 is communicatively coupled (or otherwise has access) to a search cluster 118. The general purpose of the search cluster 118 is to perform searches in response to the user queries inputted via the query interface 106 and to output search results to be presented to the user using the search results interface 108. What follows is a description of one non-limiting embodiment of the implementation for the search cluster 118. However, it should be understood that there is a number of alternative non-limiting implementations of the search cluster 118 possible. It should be also expressly understood that in order to simplify the description presented herein below, the configuration of the search cluster 118 has been greatly simplified. It is believed that those skilled in the art will be able to appreciate implementational details for the search cluster 118 and for components thereof that may have been omitted for the purposes of simplification of the description.

Generally speaking the purpose of the search cluster 118 is to (i) conduct searches (details will be explained herein below); (ii) execute analysis of search results and perform ranking of search results; (iii) group results and compile the search result page (SERP) to be outputted to the electronic device 102. How the search cluster 118 is configured to execute searches is not particularly limited. Those skilled in the art will appreciate several ways and means to execute the search using the search cluster 118 and as such, several structural components of the search cluster 118 will only be described at a high level.

In some non-limiting embodiments of the present technology, the search cluster 118 comprises a processing module 120. The processing module 120 can execute several searches, including but not limited to, a general search and a vertical search. To that end, the processing module 120 comprises (or has access to) a web search module 122. The web search module 122 is configured to perform general web searches, as is known to those of skill in the art.

In some non-limiting embodiments of the present technology, processing module 120 can execute what is known as a multi-level search. These non-limiting embodiments can be implemented, for example, to increase the speed of the search and to obtain more relevant search results. In some non-limiting embodiments of the present technology, the web search module 122 can be responsible for executing the multi-level search.

To that end, the web search module 122 can execute the top level meta search, as will be discussed in greater detail herein below. The web search module 122 may also have access to a database DB_{WEB} 132, which database DB_{WEB} 132 may be accessed by the web search module 122 to conduct a middle level meta search and a bottom level search. Even though the database DB_{WEB} 132 is depicted as a single entity, in some non-limiting embodiments of the present technology, the database DB_{WEB} 132 can be implemented in a distributed manner, for example as a dedicated database for each of the middle level meta search and the bottom level search.

Also, even though the web search module 122 is depicted as a single entity, in alternative non-limiting embodiments of the present technology the web search module 122 may also be implemented in a distributed manner. For example, each of the distributed implementations of the web search modules 122 may be dedicated to search queries originating from a particular geographical region. In those non-limiting embodiments of the present technology, the processing module 120 may determine a location and/or an IP address associated with the electronic device 102 associated with the user who is submitting the search query. Based on the so-determined location and/or the IP address of the electronic device 102, the processing module 120 may forward the search query to one of the distributed web search modules 122 to perform the top level meta search.

The web search module 122 may also forward a request to the database DB_{WEB} 132 to perform the middle level meta search and the bottom level search. In some non-limiting embodiments of the present technology, the database DB_{WEB} 132 may have a portion (or a separate database) dedicated to the middle level meta search (for example, having a repository of frequently asked questions). The identification of the portion (or a separate database) of the database DB_{WEB} 132 responsible for the middle level meta search may be executed by the database DB_{WEB} 132 based on a so-called “CRC-code”. The portion (or a separate database) of, the database DB_{WEB} 132 responsible for the middle level meta search may send a given generated query to a portion (or a separate database) of the database DB_{WEB} 132 responsible for the bottom level search.

However, in some non-limiting embodiments of the present technology, where the search query is already saved in cache of the portion (or the separate server) of the database DB_{WEB} 132 as part of the middle level meta search, the step of transmitting the query to the portion (or the separate database) of the database DB_{WEB} 132 responsible for the bottom level search may be omitted altogether. Naturally, in alternative embodiments of the present technology, even if the search query is already saved in cache of the portion (or the separate server) of the database DB_{WEB} 132 as part of the middle level meta search, the step of transmitting the query to the portion (or the separate database) of the database DB_{WEB} 132 responsible for the bottom level search may still be performed.

The processing module 120 further comprises (or has access to) a plurality of vertical search modules 123. In the depicted non-limiting embodiment, the plurality of vertical search modules includes a vertical 1 module 124, a vertical 2 module 126 and a vertical N module 128. It should be expressly understood that the number of modules within the plurality of vertical search modules 123 is not meant to be a limitation of embodiments of the present technology.

Merely for the purposes of ease of illustration, it shall be assumed that the vertical 1 module 124 is implemented as a vertical search domain for searching maps and other geographical information. As such, it can be said that the vertical 1 module 124 implements a map vertical search engine or, simply, a map service.

Furthermore, it shall be assumed that the vertical 2 module 126 is implemented as a vertical search module for searching images. As such, it can be said that the vertical 2 module 126 implements an images vertical search domain or, simply, an image service. For the various examples to be provided herein below, it shall be assumed, selectively, that the vertical N search module 128 can implement one of sports news, movies, weather, translation, wiki or movie theater services. It should be expressly understood that a number of additional or different services can be implemented as part of the plurality of vertical search modules 123.

In some non-limiting embodiments of the present technology, any given one of the plurality of vertical search modules 123 comprises or has access to one or more databases. These one or more databases host data associated with the particular service implemented by the given one of the plurality of vertical search modules 123.

To that extent, the vertical 1 module 124 has access to a database DB_{V1} 134. Recalling that the vertical 1 module 124 implements a map service, the database DB_{V1} 134 contains information related to geographical location of various objects and the associated maps. The vertical 2 module 126 has access to a database DB_{V2} 136. Recalling that the vertical 2 module 126 implements an image service, the database DB_{V2} 136 can host a repository of various images. By the same token, the vertical N module 128 has access to a database DB_{VN} 138. Recalling that the vertical N module 128 implements selectively one of sports news, movies, weather, translation or movie theater services, the database DB_{VN} 138 can host a repository of data associated with the respective selective service.

Additionally or optionally and, as known to those skilled in the art, the one or more . databases (such as the database DB_{V1} 134, DB_{V2} 136 and DB_{VN} 138) may be segregated into one or more separate databases. These segregated databases may be portions of the same physical database (such as the database DB_{V1} 134, database DB_{V2} 136 and database DB_{VN} 138) or may be implemented as separate physical entities. For example, one database within, let's say, the database DB_{V2} 136 could host the most popular/most frequently requested images in a given category, while another database within the database DB_{V2} 136 could host all the images available within the image service. Needless to say, the above has been provided as an illustration only and several additional possibilities exist for implementing embodiments of the present technology.

Furthermore, it is possible that some of the plurality of vertical search modules 123 may not implement a separate database. This is particularly true, but is not limited to, for example, the vertical N module 128 implementing a weather service. In this example, the vertical N module 128 implementing the weather service may not have a dedicated database, but may rather have access to a service widget repository 130. The service widget repository 130 may be implemented as data repository for one or more widget applications, as will be described in greater detail here below.

Each of the plurality of vertical search modules 123 is configured to perform vertical searches within the respective databases (i.e. database DB_{V1} 134, database DB_{V2} 136 and database DB_{VN} 138). However, it should be noted that the search capabilities of the plurality of vertical search modules 123 are not limited to searching the respective databases (i.e. database DB_{V1} 134, database DB_{V2} 136 and database DB_{VN} 138). As such, the plurality of vertical search modules 123 may perform other searches, as the need may be.

Also, for the purposes of the description presented herein, the. term “vertical” (as in vertical search or in vertical search domain) is meant to connote a search performed on a subset of a larger set of data, the subset having been grouped pursuant to an attribute of data. For example, to the extent that the vertical 2 module 126 implements an image service, the vertical 2 module 126 searches a subset (i.e. images) of the set of data (i.e. all the data potentially available for searching), the subset of data being stored in the database DB_{V2} 136.

In some non-limiting embodiments of the present technology, some or all of the search results returned by a respective one of the vertical search modules 123 can be formatted into a widget application. In a sense, the widget application is a particular way to represent the search results from a given vertical search of one of the plurality of vertical search modules 123.

Merely for the purposes of simplifying the description to be presented herein, only a high level description of one approach to executing a search by the search cluster 118 will be presented herein below. It is expected that those skilled in the art will be able to configure the search cluster 118 in any number of known ways without undue experimentation or burden.

As has been mentioned above, in some non-limiting embodiments of the present technology, the processing module 120 can be configured to execute a search in a multi-level meta fashion. In some non-limiting embodiments of the present technology, the processing module 120 includes an http-interface (not depicted) for receiving the search request from the server 116.

When the processing module 120 receives the search query from the server 116, it sends the search query to the web search module 122. As has been alluded to above, in some non-limiting embodiments of the present technology, the sending of the search request to the web search module 122 may be based on the location and/or IP address associated with the electronic device 102, as may be determined by the processing module 120. The web search module 122 performs a search, which in some non-limiting embodiments of the present technology may include a multi-level search. To that extent, the web search module 122 executes some or all of the top level meta search, middle level middle search and the bottom level search.

In parallel or in sequence, the processing module 120 also transmits the search query to the plurality of vertical search modules 123 for performing the respective vertical searches. The responses from all the search sources (the plurality of vertical search modules 123 and the web search module 122, which may include the bottom level search, the middle level meta search and the top level meta search) are received and amalgamated by the processing module 120.

The processing module 120 then executes a ranking function to generate a ranked search results set. In other words, the processing module 120 ranks the search results by their relevancy to the search query submitted by the user. As those skilled in the art will appreciate, relevancy within this description shall mean how responsive a given search result is to the user query.

Those skilled in the art will appreciate various techniques available for ranking search results. Just as an example and not as a limitation, some of the known techniques for ranking search results by relevancy are based on some or all of: (i) how popular a given search query or a response thereto is in either the plurality of vertical search modules 123 or in the bottom level search (or any other level of the multi level search); (ii) how many results have been returned by either the plurality of vertical search modules 123 or in the bottom level search (or any other level of the multi level search); (iii) whether the search query contains any determinative terms (such as “images”, “movies”, “weather” or the like), (iv) how often a particular search query is typically used with determinative terms by other users; and (v) how often other uses performing a similar search have selected a particular resource or a particular vertical search results when results were presented using the standard SERP.

Within this description, the term “determinative term” shall mean a word or a string of words indicative of the fact that a given search result is more likely to have the most relevant response to the user search query. For example, if the search query contains the term “images” it can .be determined, by the processing unit 120, that the vertical 2 module 126, being implemented as an image service, is likely to be the service that contains the most relevant results to the user query. Needless to say, only a sub set of these, or these combined to others or any combination of other factors my be taken into account when ranking the search results for relevancy.

The search cluster 118 is then configured to transmit ranked search results to the server 116.

According to embodiments of the present technology, at least one result within the ranked search results presented on a SERP is associated with a booking interface. Generally speaking, the booking interface allows the user to make a booking with a resource associated with the search result without leaving the SERP. In other words, the user can make a booking (such as but not limited to an appointment, for example) without accessing the web page associated with the resource associated with the search result.

The type of the booking interface is not particularly limited and will depend, naturally, on the type of the resource it is associated with. As an example non-exhaustive list, the booking interface can be for booking an appointment with a hairdresser, a spa, a dentist, a doctor, a car mechanic and the like; a reservation for a table at a restaurant; purchasing a movie ticket, purchasing an airline ticket and the like.

In some embodiments of the present technology, the booking interface can be presented directly on the SERP, for example, as part of an information snippet associated with the search result. Alternatively, the information snippet may comprise an actuation button for indicating user's desire to make an appointment and, upon user actuation of the actuation button, the booking interface may be presented on the SERP. An example technology enabling such two-level presentation of the SERP is described in a co-owned patent application entitled A METHOD OF PRESENTING INFORMATION ON A SEARCH RESULT PAGE and bearing an attorney docket number 34055-221, content of which is hereby incorporated by reference in its entirety in all those jurisdictions where incorporation by reference is permissible.

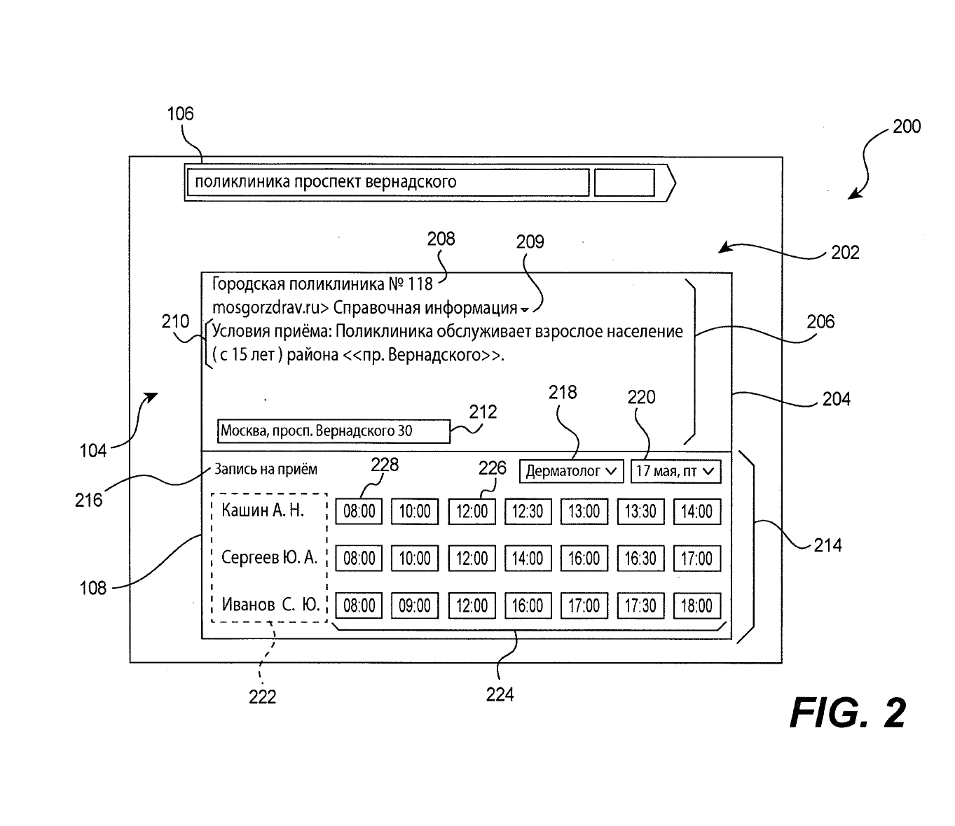

With reference to FIG. 2, there is depicted a screen shot 200, the screen shot 200 depicting the above referenced search application 104, the search application 104 being implemented in accordance with non-limiting embodiments of the present technology. Within the illustrated embodiment, the web browser implementing the search application 104 is Explorer™ browser accessing the Yandex™ search engine. However, in alternative embodiments, any commercially available or proprietary browser executing any commercially available or proprietary search engine can be used.

To that extent, the search application 104 implements the query interface 106 and the search results interface 108. As has been previously described, the search results interface 108 is configured to display to the user ranked search results in a form of a SERP 202. Generally speaking, the SERP 202 displays a number of search results, only one of which—a search result 204—is depicted in FIG. 2 for the sake of simplicity. The search result 204 is one of a plurality of search results (not depicted) potentially present within the SERP 202.

The search result 204 (as well as the plurality of search results potentially present within, the SERP 202) are responsive to a search query submitted by the user using the query interface 106. In this specific example, the user has submitted a search. query “Clinic, Vernandsky Prospect” (written in Russian as “ [symbol] [symbol] [symbol] ”). The search result 204, thus, can be said to be responsive to the search query having been entered into the query interface 106.

The search result 204 includes an information snippet 206 associated with the resource. The information snippet 206 can be generated automatically by the server 116. For example, it is known to generate the information snippet 206 based on key words present in the search query by pulling sentences or portions thereof from the main page of the web site associated with the resource, the sentences or portions thereof containing the key words.

Alternatively, the information snippet 206 can be based at least in part on information provided by the resource associated with the search result 204. An example of such a technology is disclosed in the co-owned patent application assigned to the same Applicant, having the title A METHOD OF PRESENTING INFORMATION ON A SEARCH RESULT PAGE and bearing attorney Docket Number 34055-220, content of which is hereby incorporated by reference in its entirety in all those jurisdictions where incorporation by reference is permissible.

The information snippet 206 further comprises a title field 208. The title field 206 is for providing a title associated with the resource associated with the search result 204. Within the illustrated embodiment, the title field 208 includes, in Russian, “General Hospital No. 118” (“ [symbol] [symbol] N, 118”).

The information snippet 206 further comprises an address field 209. The address field 209 is for providing information regarding an address associated with the resource. In the illustrated embodiment, the address field 209 shows both a Universal Resource Locator (URL) and an indication of a sub-resource within the resource, the sub-resource being associated with some or all information depicted within the information snippet 206. The URL in the depicted example is shown as “mosgorzdray.ru”. The sub-resource tag is depicted as “Contact Information” (in Russian, “ [symbol] [symbol] ”).

The information snippet 206 further comprises a write-up portion 210. Generally speaking, the write-up portion 210 provides certain contextual information about the resource to the user. Within the illustrated embodiment, the write-up portion 210 includes information in respect to patient acceptance rules. The write-up portion 210, in the illustrated embodiment, includes in Russian: “Appointment rules: Clinic accepts adult patients (15 years old and above) from “Pr. Vernadskogo” region” (“ [symbol] [symbol] : [symbol] [symbol] [symbol] [symbol] ( [symbol] 15 [symbol] ) [symbol] “ [symbol] . [symbol] ”).

The information snippet 206 further includes an actuation button 212. In the specific illustrated embodiment, the actuation button 212 is implemented as a button for requesting a map of the establishment associated with the resource associated with the search result 204. To that end, the actuation button 212 includes the address of the establishment associated with the resource associated with the search result 204. Upon actuation of the actuation button 212, the SERP 202 may be augmented with a map associated with the establishment associated with the resource associated with the search result 204. The map can be presented either directly within the SERP 202 or in a pop-up window. An example technology enabling such two-level representation of the map within the SERP 202 is described in the above-mentioned co-owned patent application entitled A METHOD OF PRESENTING INFORMATION ON A SEARCH RESULT PAGE and bearing an attorney docket number 34055-221.

It should be noted that the write-up portion 210 may be implemented differently and provide other type of information. Same applies to the whole composition of information snippet 206. In alternative non-limiting embodiments, the information snippet 206 can have any other combination of fields, including some or all of the fields recited above in combination with a number of additional fields.

The search result 204 further comprises a booking interface 214. Generally speaking, the booking interface 214 is for enabling the user to execute a booking with the resource associated with the search result 204 without leaving the SERP 202. In some embodiments, the booking interface 204 is for allowing the user to execute a booking without being presented with a pop-up window or the like for the booking interface 204 (i.e. booking interface 204 is located within SERP 202).

What is presented below is just one example of the implementation of the booking interface 214—those skilled in the art will appreciate that the exact implementation of the booking interface 214 will depend on the nature of the resource it is associated with and, hence, the service being booked.

Within the illustration of FIG. 2, the booking interface 214 comprises a booking interface title 216 of the booking interface 214, which in this case read in Russian “Appointment Booking” (i.e. “ [symbol] [symbol] ”). The booking interface 214 further comprises a specialist selection filed 218. The specialist selection field 218 allows the user to select a specialist that the appointment is to be made with, which in this case has been selected to be “Dermatologist” (in Russian, “ [symbol] ”). When the user actuates the drop down menu, the user may be presented with a number of options to choose from, which in which example may include: “Family Doctor”, “Cardiologist”, “Neurologist”, “Podiatrist” and the like.

The booking interface 214 further includes, in the illustrated embodiment, a date slot selection field 220. The date slot field 220 allows the user to select the date for the appointment to be made. In the depicted embodiment, the date slot field 220 is populated with “May 17^{th}, Friday” (in Russian, “17 [symbol] , [symbol] ”).

Generally speaking, the date slot field 220 allows the user to select a particular date slot for the appointment being booked. As such and as known to those of skill in the art, the date slot field 220 may be implemented in several form factors. What is presented herein above is but just one example of such an implementation and other implementations are possible. When the user activates the date slot field 220, the user may be presented with a pop-up window depicting a calendar for enabling the user to pick a date for the appointment.

There is also provided a professionals list field 222, which in the illustrated embodiments presents a list of professionals available for an appointment booking. In some embodiments of the present technology, the selection of names available within the professional list field 222 may be dependent on selections made in other fields.

For example, the list of professionals listed within the professional list field 222 may be dependent (i.e. be in a master-slave relationship) with the selection made within the specialist selection field 220. For example, the professionals listed within the professional list field 222 are corresponding to the selection made in the specialist selection field 220 (i.e. they are all Dermatologists). Consider now an example where the user changes the selection made within the specialist selection field 220—the options presented within the professional list field 222 will also change. Additionally or alternatively, the list of professionals listed within the professional list field 222 may be dependent (i.e. be in a master-slave relationship) with the selection made within the date slot field 222.

The booking interface 214 further includes a time selection matrix 224. The time selection matrix 224 allows the user to select a specific time for an appointment to be booked. It should be expressly understood that even though the time selection matrix 224 is presented in a specific form factor within the illustration of FIG. 2, in alternative embodiments the time selection matrix 224 can be implemented in a number of additional form factors. For example, but not limited so, the time selection matrix 224 can be implemented as a drop down menu (or a series of drop down menus), a check box selection matrix and the like.

Within the specific illustration of the time selection matrix 224 presented within FIG. 2, the time selection matrix 224 comprises a number of highlighted time slots 226 and a number of un-highlighted time slot 228. Within the depicted embodiments, the highlighted time slots 226 are representative of time slots available for a booking, while the un-highlighted slots 228 are indicative of time slots that are unavailable for a booking (for example, those time slots may have already been booked or the specialist may be on a break during that particular time slot).

For example, the 10 am slot for a first specialist is an available time slot, while the 10 am slot for a second specialist is not available. Accordingly, the 10 am slot for the first specialist is associated with one of the highlighted time slots 226, while the 10 am slot for the second specialist is associated with one of the un-highlighted time slots 228. It should be noted that even though in the specific embodiment being depicted herein, the difference between the number of highlighted time slots 226 and the number of un-highlighted time slot 228 is implemented as the shades of darker and lighter black or grey, alternatively, the difference may be implemented as different color, different shape, different size of the like of the number of highlighted time slots 226 and the number of un-highlighted time slots 228.

We will now turn our attention to how the information for the booking interface 214 is generated by the server 116. Generally speaking, it can be said that the booking interface 214 contains one or more data components, which content may change from time to time. The content may change based on the user selection within the booking interface 214 or it may change based on other users making reservations with the resource associated with the booking interface 214. For example, depending on the date selected by the user within the date slot field 220, one or more of the following lists may need to be updated: the professional list field 222; the time selection matrix 224, etc. Alternatively, consider a scenario where another user has made an appointment with the first specialist for the 10 am slot. The 10 am slot, therefore, needs to be changed from one of the highlighted time slots 226 to one of the un-highlighted time slots 228.

Generally speaking, the data component that needs to be updated within the booking interface may include one or more of: the specialist selection filed 218; the date slot field 220; the time selection matrix 224 (namely, the number of highlighted time slots 226 and the number of un-highlighted time slot 228), etc.

It should be expressly understood that the type and the number of the data components to be generated and/or updated within the booking interface 214 is not limited to what is described here. The type and the number of the data components to be generated and/or updated within the booking interface 214 will depend on the type of the booking interface, which in turn will depend on the type of the resource the booking interface 214 is associated with.

For the avoidance of doubt, the term “data component data” as used herein shall mean data required to generate and/or update at least a portion of the booking interface 214 (i.e. to generate and/or update a data component), namely the specialist selection filed 218; the date slot field 220; the time selection matrix 224 (namely, the number of highlighted time slots 226 and the number of un-highlighted time slot 228), etc or any other field potentially present within the booking interface 224. For example, a data component data required to generate the time selection matrix 224 includes information about which time slots are available which time slots are un-available.

Generally speaking, a data component within the booking interface .214 can be generated by the server 116 by means of: (i) downloading a data component data from the resource as part generating the SERP 202; (ii) downloading the data component data from a memory as part of generating the SERF 202, the data component data having been stored in the memory at a point of time prior to generating the SERF 202.

We will now explore the two options in turn.

Within some embodiments of the present the data component data for the booking interface 214 (i.e. some or all of the specialist selection filed 218; the date slot field 220; the time selection matrix 224 (namely, the number of highlighted time slots 226 and the number of un-highlighted time slot 228) can be generated and/or updated by means of downloading the data component from the resource associated with the booking interface 214. Accordingly, within these embodiments of the present technology, it can be said that the data component data for the booking interface 214 is appreciated as part of the process of generating the SERP 202 by the server 116.

Within some embodiments of the present technology, this information can be appreciated through an application program interface (API). As part of generating data for the SERP 202, the server 116 may query the resource associated with the booking interface 214 via the API and receive the data component data required to generate one or more of the specialist selection filed 218; the date slot field 220; the time selection matrix 224 (namely, the number of highlighted time slots 226 and the number of un-highlighted time slot 228).

Alternatively, the data component data can be obtained in an XML file. As part of generating data for the SERP 202, the server 1_{.}16 may query the resource associated with the booking interface 214 and receive an XML file containing the data component data required to generate one or more of the specialist selection filed 218; the date slot field 220; the time selection matrix 224 (namely, the number of highlighted time slots 226 and the number of un-highlighted time slot 228).

Alternatively, the data component data can be received from the resource associated with the booking interface 214 as part of an HTML file. Those skilled in the art, having benefit of the teachings of the present description, will appreciate other types of files or communication means to enable the server 116 to receive the data component data from the resource associated with the booking interface 214 to enable generation of one or more of the specialist selection filed 218; the date slot field 220; the time selection matrix 224 (namely, the number of highlighted time slots 226 and the number of un-highlighted time slot 228).

Within alternative embodiments of the present technology, the data component data for the booking interface 214 (i.e. some or all of the specialist selection filed 218; the date slot field 220; the time selection matrix 224 (namely, the number of highlighted time slots 226 and the number of un-highlighted time slot 228) can be generated and/or updated by means of downloading the data component data from a memory as part of generating the SERF 202, the data component data having been stored in the memory at a point of time prior to generating the SERP 202. In some embodiments, the server 11 is configured to crawl the Internet to index Internet resources. As part of indexing, the server 116 may store information about the indexed resources in one or more databases, such as for example, the database DB_{WEB} 132.

As part of the crawling and indexing the web site associated with the resource associated with the booking interface 214 to be presented on the SERP 202, the server 116 can also receive the data component data that can be used to generate the booking interface 214 at a point of time thereafter. How, the server 116 receives the data component data is not particularly limited. Within some embodiments of the present technology, this information can be appreciated through the above-mentioned API. Alternatively, the data component data can be obtained in an XML file. Alternatively, the data component data can be received from the resource associated with the booking interface 214 as part of an HTML file.

It should be understood that one of the method for appreciating the data component data lends itself to certain types of booking interfaces 214, while the other method lends itself more easily to other types of booking interfaces 214. For example, the selection of which method of data component data retrieval is better suited for a particular type of the booking interface may, for example, be made based on a life cycle timespan of the information within the given booking interface 214. For example, if the data has a shorter life cycle timespan (i.e. it is updated on a frequent basis), such as for example, information associated with an appointment for a spa treatment, it may be more beneficial to obtain the data component data in “real time”—i.e. as part of generating the SERP 202. If, on the other hand, the life cycle timespan is longer (i.e. it is updated in a less frequent basis), such as for example, information associated with a luxury cruise, it maybe more beneficial to obtain the data component data from the “cache” of the one or more databases. The latter has a benefit of a faster search—i.e. the ability to retrieve and present the booking interface 214 relatively faster.

In yet additional non-limiting embodiments of the present technology, it is possible to mix the two approaches described above. Within a given one booking interface 214 some of the data component data may have a shorter life cycle timespan and some of the data component data may have a longer life cycle timespan. Within such embodiments, those of the data component data that have a short life cycle timespan maybe be appreciated while generating the information for the SERP 202, while those of the data component data that have a longer life cycle timespan may be appreciated from the one or more databases (i.e. be, in a sense, cached).

Using the booking interface 214 as example, the specialist selection field 220 and the professionals list field 222 may be associated with data component data having a relatively longer life cycle timespan and, therefore, the data component data associated therewith may be appreciated from the stored information in one or more databases. On the other hand, the time selection matrix 224 (namely, the number of highlighted time slots 226 and the number of un-highlighted time slot 228) may be deemed to have a comparatively shorter life cycle timespan and, as such, data component data associated therewith may be appreciated in real-time while generating the SERF 202. This hybrid approach to downloading data component data provides an additional benefit of reducing search time, while ensuring that the data component data is “fresh”—i.e. provide the most up-to-date information.

Once the user makes a selection using the booking interface 214, the information is transmitted to the resource associated with the booking interface 214. In some embodiments, the information can be exchanged via an application program interface (API). Once the resource receives the booking information, the booking can be made in the internal reservation system of the resource. Accordingly, the user is enabled to make the appointment with the resource directly on the SERP 202. Put another way, the user is enabled to make the appointment with the resource without leaving the SERP 202. Put yet another way, the user is enabled to make the appointment with the resource without visiting a web site associated with the resource.

Once the appointment is booked, if any other user tries to use the booking interface 214 to book an appointment, the so-booked time slot will show as no longer available.

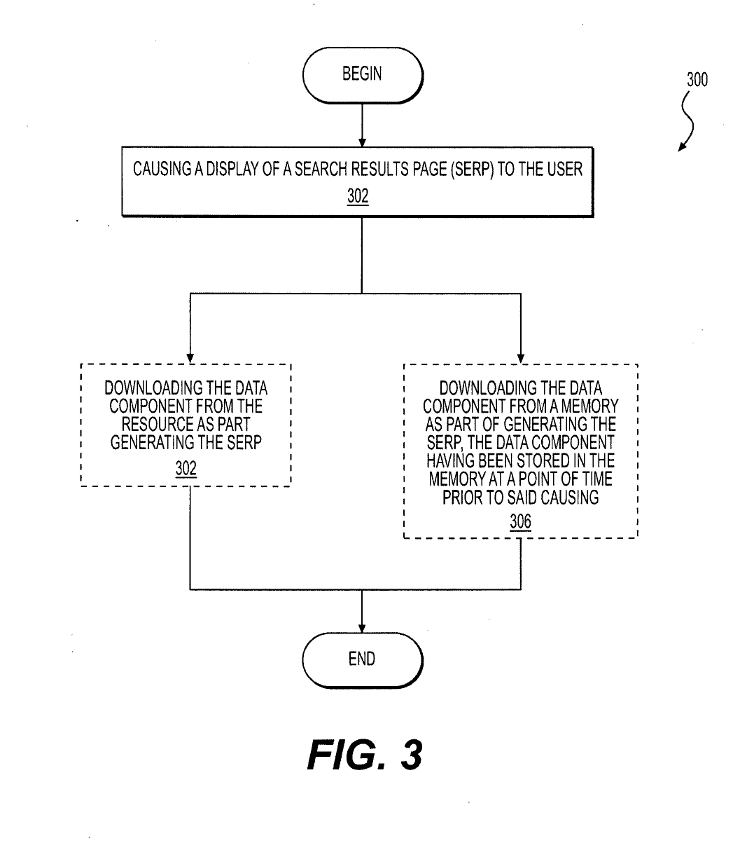

Given the architecture of FIG. 1 and the example provided with reference to FIG. 2, it is possible to execute a method of displaying search results to a user in response to a search query. The method can be conveniently executed at the server 116. To that extent, the server 116 comprises non-transient computer usable information storage medium that enables the server 1.16 to execute the method in accordance with embodiments of the present technology. With reference to FIG. 3, there is depicted a non-limiting embodiment of a method 300, the method 300 for displaying search results to a user.

Step 302—causing a display of a search result page (SERF 202) to the user

The method 300 begins at step 302, where the server 116 causes a display of the search result page (SERP 202) to the user

Specifically, the server 116 causes the electronic device 102 associated with the user to display a search result page (SERP 202). How the server 116 executes this step is not particularly limited. In some embodiments of the present technology, the server 116 first executes the search for the user query submitted using the query interface 102 and obtains the ranked search results (for example, using some of the search approaches described herein above). For example, the server 116 may execute the above-described multi level search.

The server 316 can then cause the electronic device 102 to display the SERP 202 to the user. In some specific embodiment, the server 316 sends the electronic device 102 a JSON message containing the information necessary to trigger and enable the electronic device 102 to display the SERP 202.

Within embodiments of the present technology, the SERP 202 to be displayed to he user includes a number of search lines, each search line being associated with a resource being responsive to the search query. Within the SERP 202 provided to the user, at least one search result line has a booking interface associated with a resource, such as the booking interface 214 being associated with its respective resource. As has been described above, the booking interface 214 enables the user to execute a booking with the resource without leaving the SERP 202.

The booking interface 214 has a data component, the data component having been generated using one of (i) downloading a data component data from the resource as part of generating the SERP 202; (ii) downloading the data component data from a memory as part of generating the SERP 202, the data component data having been stored in the memory at a point of time prior to executing method 300.

As has been described above and using the booking interface 214 as an example, the data component data can be instrumental in generating and/or updating one or more of: the specialist selection filed 218; the date slot field 220; the time selection matrix 224 (namely, the number of highlighted time slots 226 and the number of un-highlighted time slot 228).

Now, depending on the implementation of the method 300, the method 300 also includes one or steps 304 or 306.

Step 304—downloading the data component data from the resource as part generating the SERP 202

In some embodiments of the present technology, as part of executing step 304, the server 116 downloads the data component data from the resource associated with the booking interface 214. Step 304 can be executed as part of generating the information for the SERP 202 by the server 116. In other words, the execution of step 304 can be done at the same time as executing step 302.

Step 306—downloading the data component data from a memory as part of generating the SERP 202, the data component data having been stored in the memory at a point of time prior to said causing

In some embodiments of the present technology, as part of executing step 306, the server 116 downloads the data component data from the memory. As has been described above, the server 116 can download the data component data from the DB_{WEB} 132. Within these embodiments, the data component data has been stored in the DB_{WEB} 132 at a point of time prior to executing the method 300. Step 306 can be executed as part of generating the information for the SERP 202 by the server 116 (the downloading part), while the actual storage of the data component data in the DB_{WEB} 132 is executed prior to the execution of the method 300.

In some embodiments of the present technology, the method 300 further includes a step of storing the data component data into the memory (such as DB_{WEB} 132), the step of storing executed prior to the execution of step 302.

In some embodiments, the method 300 may include execution both of steps 302 and 306. This is particularly true in those embodiments, where some of the data component data within the booking interface 214 are generated or updated using step 304 and others are generated or updated using step 306.

Now, it should be understood that the above description has been presented as an example only and numerous alterative implementations are possible. For example, within the example illustrated above, the SERP 202 has multiple search results lines and one of the multiple search result lines is associated with the booking interface 214. In alternative embodiments of the present technology, the SERP 202 may have several search results lines associated with a respective booking interface. For example, one line may be associated with the booking interface 214 and another line may be associated with a booking interface similar to the booking interface 214, but configured for booking a movie theatre ticket, for example. Each of the booking interfaces are associated with the respective resource. Recalling that the booking interface 214 can exchange data with the associated resource via an API, it can be said that the two booking interfaces can work independently from each other. Put another way, the two interfaces can be used in parallel by the user (i.e. user can manipulate and/or make reservations using both booking interfaces at substantially the same time).

It should be expressly understood that not all technical effects mentioned herein need to be enjoyed in each and every embodiment of the present, technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of displaying search results to a user in response to a search query, the method executable at a server, the method comprising:
causing a display of a search result page (SERP) to the user, at least one line within the SERP having a booking interface associated with a resource, the booking interface enabling the user to execute a booking with the resource without leaving the SERP;
the booking interface having data components comprising data component data having a relatively longer life cycle timespan within the booking interface and data component data having a comparatively shorter life cycle timespan within the booking interface, the data components having been generated by:
for a data component data having the comparatively shorter life cycle timespan, downloading the data component data from the resource as part of generating the SERP; and
for a data component data having the relatively longer life cycle timespan, downloading the data component data from a memory as part of generating the SERP, the data component data having been stored in the memory at a point of time prior to said generating.

2. The method of claim 1, said booking interface being a first booking interface, wherein said resource is a first resource and wherein said causing comprises;
causing a display of a search result page (SERP) to the user, at least one line within the SERP having the first booking interface associated with said first resource and a second search line having a second booking interface associated with a second resource.

3. The method of claim 2, wherein said first resource is different from said second resource.

4. The method of claim 2, wherein said first booking interface and said second booking interface allow the user to interact with them independently from each other.

5. The method of claim 2, wherein said first booking interface and said second booking interface allow the user to make a booking substantially at the same time.

6. The method of claim 1, wherein the data component data has been generated by means of downloading the data component data from the resource as part generating the SERP and wherein the method further comprises downloading the data component data.

7. The method of claim 6, wherein downloading the data component data comprises downloading the data component data from the resource.

8. The method of claim 6, wherein said downloading is executed by means of an application program interface (API).

9. The method of claim 1, wherein the data component data has been generated by means of downloading the data component data from a memory as part of generating the SERP, the method further comprising downloading the data component data from the memory.

10. The method of claim 9, wherein the method further comprises receiving the data component data and storing it in the memory, both receiving and storing being executed prior to said generating.

11. The method of claim 10, wherein said receiving is executed by means of an application program interface (API).

12. The method of claim 1, wherein the booking interface allows the user to input booking data.

13. The method of claim 12, further comprising causing transmission of the booking data to the resource.

14. The method of claim 13, wherein the transmission is executed via an application program interface (API).

15. The method of claim 1, wherein the data components are a first data component and a second data component, wherein:
the first data component is generated by downloading the first data component data from the resource as part of generating the SERP;
the second data component is generated by downloading a second data component from a memory as part of generating the SERP, the second data component data having been stored in the memory at a point of time prior to said generating.

16. A server having a non-transient computer usable information storage medium that stores computer executable instructions, which instructions when executed are configured to render the server operable to execute:
causing a display of a search result page (SERP) to the user, at least one line within the SERP having a booking interface associated with a resource, the booking interface enabling the user to execute a booking with the resource without leaving the SERP;
the booking interface having a data component comprising data component data having a relatively longer life cycle timespan within the booking interface and data component data having a comparatively shorter life cycle timespan within the booking interface, the data component having been generated by:
for a data component data having the comparatively shorter life cycle timespan, downloading the data component data from the resource as part of generating the SERP; and
for a data component data having the relatively longer life cycle timespan, downloading the data component data from a memory as part of generating the SERP, the data component data having been stored in the memory at a point of time prior to said generating.

17-30. (canceled)

31. The method of claim 1, further comprising determining, before generating the data component, whether the data component data has a relatively longer life cycle timespan within the booking interface or whether the data component data has a relatively shorter life cycle timespan within the booking interface.

32. The method of claim 1, further comprising updating the data component data based on a user selection within the booking interface.

33. The method of claim, further comprising updating the data component data based on a user interaction with the resource associated with the booking interface.
